(19) United States
(12) Patent Application Publication
(10) Pub. No.: US 2021/0063169 A1
(43) Pub. Date: Mar. 4, 2021

(54) METHOD AND DEVICE FOR CREATING A MAP

(71) Applicant: Robert Bosch GmbH, Stuttgart (DE)

(72) Inventors: Peter Christian Abeling, Hannover (DE); Christian Passmann, Diekholzen (DE); Daniel Zaum, Sarstedt (DE)

(21) Appl. No.: 16/643,325

(22) PCT Filed: Aug. 16, 2018
(86) PCT No.: PCT/EP2018/072277

§ 371 Date: Feb. 28, 2020

(30) Foreign Application Priority Data
Sep. 8, 2017 (DE) 10 2017 215 868.9

(51) Int. Cl. G01C 21/32; G01C 21/36; G06K 9/00

(52) U.S. Cl. CPC G01C 21/32; G06K 9/00791; G01C 21/367; G01C 21/3694

(57) ABSTRACT

A method and a corresponding device are described for creating a first map. The method includes receiving surroundings data values representing surroundings of a vehicle, the surroundings encompassing at least one surroundings feature, the surroundings data values being detected using a first surroundings sensor system of the vehicle. The method also includes determining an object class of the surroundings feature, as a function of the first surroundings sensor system of the vehicle, and creating an assignment of the object class to at least one further object class. The further object class is determined proceeding from at least one further surroundings feature, the further surroundings feature being detectable with using a second surroundings sensor system. The second surroundings sensor system is not identical in design to the first surroundings sensor system. The method also includes creating the first map, as a function of the surroundings data values, based on the assignment.

### FIELD

The present invention relates to a method and to a device for creating a first map, including a step of receiving surroundings data values, the surroundings data values representing surroundings of at least one vehicle, the surroundings encompassing at least one surroundings feature, a step of determining an object class of the at least one surroundings feature, a step of creating an assignment of the object class to at least one further object class, and a step of creating the first map, as a function of the surroundings data values, based on the assignment.

### SUMMARY

An example method according to the present invention for creating a first map includes a step of receiving surroundings data values, the surroundings data values representing surroundings of at least one vehicle, the surroundings including at least one surroundings feature, the surroundings data values being detected with the aid of a first surroundings sensor system of the at least one vehicle, and a step of determining an object class of the at least one surroundings feature, as a function of the first surroundings sensor system of the at least one vehicle. The method furthermore includes a step of creating an assignment of the object class to at least one further object class, the at least one further object class being determined proceeding from at least one further surroundings feature, the at least one further surroundings feature being detectable with the aid of a second surroundings sensor system, and the second surroundings sensor system not being identical in design to the first surroundings sensor system, and a step of creating the first map, as a function of the surroundings data values, based on the assignment.

A first and/or second surroundings sensor system shall be understood to mean, for example, at least one video sensor and/or at least one radar sensor and/or at least one LIDAR sensor and/or at least one ultrasonic sensor and/or at least one further sensor, which is designed to detect the surroundings of the at least one vehicle in the form of surroundings data values. The fact that the second surroundings sensor system is not identical in design to the first surroundings sensor system shall, for example, be interpreted in such a way that the first surroundings sensor system includes at least one radar sensor, and the second surroundings sensor system does not include a radar sensor. In general, the first and second surroundings sensor systems differ in that they include a different number of potentially different sensor types (video, LIDAR, radar, etc.).

A detection of the surroundings data values, in particular, in the form of the at least one surroundings feature, shall, for example, be understood to mean that the at least one surroundings feature is detected and linked to a position which is determined with the aid of a navigation system, for example. In one specific embodiment, the reception of the surroundings data values takes place, for example, in such a way that the at least one surroundings feature is received in conjunction with a respective position. In one further specific embodiment, for example, the at least one surroundings feature is detected and entered into a map encompassed by the at least one vehicle (for example, by a navigation system and/or a smart phone connected to the at least one vehicle). The reception of the surroundings data values takes place in such a way that this map—together with the entered at least one surroundings feature—is received. In one further specific embodiment, in addition and/or as an alternative, the surroundings data values are received in such a way that these include a description of the first surroundings sensor system—such as an indication of the sensor type, for example.

A position shall, for example, be understood to mean (two- or three-dimensional) coordinates within a predefined coordinate system, for example GNSS coordinates. The GNSS coordinates are determined with the aid of a GNSS unit in the process, which is designed as a system for position determination and navigation on the earth and in the air by receiving signals from navigation satellites and/or pseudolites.

A surroundings feature shall, for example, be understood to mean an infrastructure feature (traffic sign, guard rail, curb, shoulder, roadway marking, etc.) and/or a structure (bridge, tunnel, building, etc.) and/or landscape features (lake, river, tree, forest, etc.). Which object in the surroundings of the at least one vehicle is actually detected, or detectable, as a surroundings feature with the aid of the first surroundings sensor system also depends on the design of the surroundings sensor system and/or of the sensor types (video, LIDAR, radar, etc.) encompassed by the first surroundings sensor system.

Within the scope of the present invention, the assignment of the first object class to at least one further object class is used synonymously with assigning the at least one surroundings feature to the at least one further surroundings feature, unless it is expressly pointed out or arises expressly from the context of the used expressions (object class, surroundings feature).

The example method according to the present invention advantageously achieves the object of assigning—with the aid of the object classes—the at least one surroundings feature to the at least one further surroundings feature, in particular, when the at least one surroundings feature and the at least one further surroundings feature are not detected with the aid of the same and/or an identical, in terms of design,—based on the sensor type—surroundings sensor system, and of creating—based on the assignment—a (shared) map (here: first map). This is of great advantage since the at least one surroundings feature and the at least one further surroundings feature do not have to be detected together, which, on the one hand, for example, reduces the memory requirement of the detected surroundings data values in the at least one vehicle and, on the other hand, allows the at least one surroundings feature and the at least one further surroundings feature to be assigned only when needed and, for example, to create a first map only when needed—and regardless of the respective utilized surroundings sensor system.

Preferably, the at least one further surroundings feature is encompassed by a second map and/or a step of providing the first map takes place in such a way that an automated vehicle is operated as a function of the first map and/or as a function of the second map and/or as a function of the assignment and/or a mobile terminal is operated as a function of the first map and/or as a function of the second map and/or as a function of the assignment. In particular, a step of providing the first map takes place in such a way that a vehicle including a driver assistance system or a driver information system is operated as a function of the first map and/or as a function of the second map and/or as a function of the assignment, it being possible for the vehicle to be an automated vehicle.

An automated vehicle shall be understood to mean a semi or highly or fully automated vehicle. An operation of the automated vehicle shall, for example, be understood to mean that—as a function of the first map—a trajectory is determined, and the vehicle is moved along this trajectory—with the aid of an automated control of a transverse and/or longitudinal control. For example, the first map is used in the process in such a way that the automated vehicle carries out a localization and/or position determination of its own position. The position is determined, for example, in that the at least one surroundings feature is detected with the aid of a surroundings sensor system of the automated vehicle and a relative position of the automated vehicle thereto is determined. This takes place, for example, with the aid of a direction vector and a distance between the at least one surroundings feature and the automated vehicle. Since the position of the at least one surroundings feature is stored in the first map, the position of the automated vehicle is determined—for example, with the aid of vector addition—proceeding from this position and the relative position. In one further specific embodiment, an operation shall be understood to mean that, for example, safety-relevant functions—for maintaining and/or for enhancing the safety of the automated vehicle and/or of at least one occupant of the automated vehicle—are carried out and/or prepared—as a function of the first map—(“readying” an airbag, tightening a seat belt, etc.).

A mobile unit shall, for example, be understood to mean a drone and/or a mobile terminal (smart phone, tablet, etc.).

A first and/or a second map shall be understood to mean a digital map which is present in the form of (map) data values on a storage medium. For example, the first and/or the second map is designed in such a way that one or multiple map layer(s) is/are encompassed, a map layer showing a map from a bird's eye view (course and position of roads, buildings, landscape features, etc.), for example. This corresponds to a map of a navigation system, for example. Another map layer encompasses a radar map, for example, the surroundings data values encompassed by the radar map being stored together with a radar signature. Another map layer encompasses a LIDAR map, for example, the surroundings data values encompassed by the LIDAR map being stored together with a LIDAR signature. Another map layer encompasses, for example, surroundings features (structures, landscape features, infrastructure features, etc.) in the form of surroundings feature data values, the surroundings feature data values encompassing, for example, a position of the surroundings features and/or further variables, such as length information about the surroundings features and/or a description whether the surroundings features are present permanently or temporarily. In one specific embodiment, the first and/or second map corresponds to a respective map layer.

This yields the advantage that, in particular, the at least one surroundings feature is combined with a second—and already existing—map, which encompasses the at least one further surroundings feature, whereby, for example, the second—already existing—map may also be (subsequently) expanded and/or adapted or corrected by the at least one surroundings feature.

The object class is preferably determined as a function of a geometrical structure of the at least one surroundings feature and/or as a function of a material property of the at least one surroundings feature.

An object class shall be understood to mean an (abstract) categorization of individual surroundings features, different abstraction levels being possible, which are at least dependent on the surroundings sensor system of the at least one vehicle. In one specific embodiment, an object class is, for example, “rod-shaped objects,” the individual surroundings features being examined according to their geometrical structure and—for example in the case of a traffic sign or a street lamp—the rod of the sign and/or of the lamp being recognized as a “rod-shaped object.” In another specific embodiment, an object class is, for example, “reflective objects,” the individual surroundings features being examined according to their material property—in particular, when the first surroundings sensor system includes at least one radar and/or LIDAR sensor.

This yields the advantage that a classification of the at least one surroundings feature is carried out quickly and in a resource-conserving manner.

The assignment of the object class to the at least one further object class is preferably created as a function of the geometrical structure of the at least one surroundings feature and/or as a function of a geometrical structure of the at least one further surroundings feature.

The assignment of the object class to at least one further object class is created as a function of the geometrical structure of the at least one surroundings feature and of a geometrical structure of the at least one further surroundings feature, in particular, due to the utilization of geometrical structures in the form of courses of roads, courses of road markings, courses of guard rails, courses of road boundaries, and/or, in particular, due to the utilization of geometrical structures formed of a characteristic pattern of point-like objects, such as poles, guide posts, traffic lights, street lamps, and/or, in particular, as a function of correlations between structures of the respective surroundings features, in particular, correlation between point clouds. In one specific embodiment, an assignment of the object class to the at least one further object class shall, for example, be understood to mean that the object class encompasses, as an object, a “rod-shaped object” having a position in a particular area—for example, a road section of approximately 5 meters—and the at least one further object class encompasses, as an object, a traffic sign having a highly precise position, the highly precise position being situated in this road section. The “rod-shaped object” is assigned to the “traffic sign,” and the object class is thus assigned to the at least one further object class—within the particular area.

A highly precise position shall be understood to mean a position which is so precise within a predefined coordinate system, for example GNSS coordinates, that this position does not exceed a maximum permissible lack of definition—for example 10 to 50 cm.

This yields the advantage that an assignment method of the object class to at least one further object class is provided, which makes it possible to assign the at least one surroundings feature—in conjunction with a position—to at least one further surroundings feature, in particular, when, for example, the at least one surroundings feature and/or the at least one further surroundings feature are each detected with a position subject to a certain lack of definition—for example several meters.

Preferably, the first surroundings sensor system includes a radar sensor, and the surroundings data values are detected with the aid of the radar sensor, the at least one surroundings feature having a characteristic radar signature. Moreover, the object class is determined as a function of the characteristic radar signature and/or the second surroundings sensor system includes a video sensor and/or a LIDAR sensor.

This yields the advantage that the method, for example compared to a video-based method, takes place regardless of lighting conditions, for example due to the daytime and nighttime or due to glare by sun rays or other light sources in the surroundings of the vehicle.

The assignment is preferably created, proceeding from the surroundings data values, with the aid of a SLAM method and/or with the aid of a correlation method.

The assignment is created, proceeding from the surroundings data values, with the aid of a SLAM method, in particular, a GraphSLAM method, and/or with the aid of a correlation method, in particular, an ICP method and/or, in particular, a least squares error minimization and/or, in particular, a non-linear transformation method.

The GraphSLAM method is used, for example, in that a global optimization for error minimization is carried out with the aid of the surroundings data values modeled as a graph. This takes place by determining the edges of the graph between the first and second maps based on correlations between the two maps with the aid of, for example, the ICP and non-linear transformation methods.

The ICP method is used in such way that spatially very close surroundings data values of different object classes are assigned to one another.

As an alternative or in addition, the method of non-linear transformation is employed in such a way that surroundings data values of different object classes are assigned to one another based on their characteristic structure resulting from their relative relationships.

The edges in the graph thus found, representing the differences between the first and the second map, are then used to determine an optimal or error-minimized assignment between the two maps, for example by applying the least squares error minimization method.

This yields the advantage that the mutually corresponding nodes in the first and second maps are identified and shifted in such a way that the maps are optimally assigned to one another with respect to a global approach. Only in this way is it possible to render a position determined in the first map (e.g., proper position of an automated vehicle) also usable in the second map.

The device according to the present invention for creating a first map includes first means for receiving surroundings data values, the surroundings data values representing surroundings of at least one vehicle, the surroundings encompassing at least one surroundings feature, the surroundings data values being detected with the aid of a first surroundings sensor system of the at least one vehicle, and second means for determining an object class of the at least one surroundings feature, as a function of the first surroundings sensor system of the at least one vehicle. The device furthermore includes third means for creating an assignment of the object class to at least one further object class, the at least one further object class being determined proceeding from at least one further surroundings feature, the at least one further surroundings feature being detectable with the aid of a second surroundings sensor system, and the second surroundings sensor system not being identical in design to the first surroundings sensor system, and fourth means for creating the first map, as a function of the surroundings data values, based on the assignment.

The first means and/or the second means and/or the third means and/or the fourth means are preferably designed to carry out the example method.

Advantageous refinements of the present invention are described here.

### BRIEF DESCRIPTION OF THE DRAWINGS

Exemplary embodiments of the present invention are shown in the figures and are described in greater detail below.

FIG. 1 shows one exemplary embodiment of the device according to the present invention.

FIG. 2 shows one exemplary embodiment of the method according to the present invention.

FIG. 3 shows one exemplary embodiment of the method according to the present invention in the form of a flow chart.

### DETAILED DESCRIPTION OF EXAMPLE EMBODIMENTS

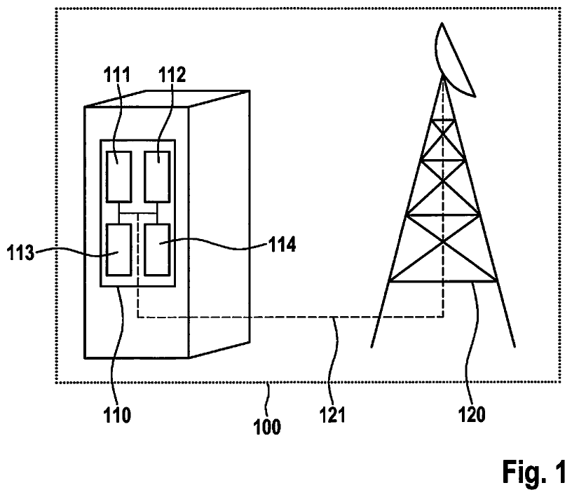

FIG. 1 shows a processing unit 100—shown by way of example—which includes a device 110 for creating 340 a first map. A processing unit 100 shall be understood to mean a server, for example. In one further specific embodiment, a processing unit 100 shall be understood to mean a cloud—i.e., a combination of at least two electric data processing systems—which exchange data via the Internet, for example. In one further specific embodiment, processing unit 100 corresponds to device 110.

Device 110 includes first means 111 for receiving 310 surroundings data values, the surroundings data values representing surroundings 220 of at least one vehicle 200, surroundings 220 encompassing at least one surroundings feature 221, the surroundings data values being detected with the aid of a first surroundings sensor system 221 of the at least one vehicle 200, and second means 112 for determining 320 an object class of the at least one surroundings feature 221, as a function of first surroundings sensor system 201 of the at least one vehicle 200. Device 110 furthermore includes third means 113 for creating 330 an assignment of the object class to at least one further object class, the at least one further object class being determined proceeding from at least one further surroundings feature, the at least one further surroundings feature being detectable with the aid of a second surroundings sensor system, and the second surroundings sensor system not being identical in design to first surroundings sensor system 201, and fourth means 114 for creating 340 the first map, as a function of the surroundings data values, based on the assignment.

First means 111 and/or second means 112 and/or third means 113 and/or fourth means 114 may—as a function of the particular specific embodiment of processing unit 100—also be designed in different specific embodiments. If processing unit 100 is designed as a server, first means 111 and/or second means 112 and/or third means 113 and/or fourth means 114 are localized in the same location—based on the location of device 110.

If processing unit 100 is designed as a cloud, first means 111 and/or second means 112 and/or third means 113 and/or fourth means 114 may be localized in differing locations, for example in differing cities and/or in differing countries, a link—such as the Internet—being designed to exchange (electronic) data between first means 111 and/or second means 112 and/or third means 113 and/or fourth means 114.

First means 111 are designed to receive surroundings data values, the surroundings data values representing surroundings 220 of at least one vehicle 200. First means 111 are designed as a transceiver unit for this purpose, with the aid of which data are requested and/or received. In one further specific embodiment, first means 111 are designed in such a way that these—proceeding from device 110—are connected to an externally situated transceiver unit 122 with the aid of a cable link and/or wireless link 121. Furthermore, first means 111 include electronic data processing elements, for example a processor, a working memory and a hard drive, which are designed to store and/or to process the surroundings data values, for example to carry out a change and/or an adaptation of the data format, and to subsequently forward these to second means 112.

In one further specific embodiment, first means 111 are designed in such a way that they forward the received surroundings data values—without data processing elements—to second means 112. In one further specific embodiment, first means 111 are designed to provide the first map and/or the second map and/or the assignment in such a way that the first map and/or the second map and/or the assignment may be received by an automated vehicle and/or by a mobile unit.

Moreover, the device includes second means 112, which are designed to determine an object class of the at least one surroundings feature 221, as a function of first surroundings sensor system 201 of the at least one vehicle 200. For this purpose, second means 112 are designed as a processing unit, for example, which includes electronic data processing elements, for example a processor, a working memory and a hard drive. Moreover, second means 112 include corresponding software which is designed to determine an object class of the at least one surroundings feature 221, as a function of first surroundings sensor system 201 of the at least one vehicle 200. The object class is determined as a function of a geometrical structure of the at least one surroundings feature 221, for example, in that individual points and/or lines and/or sub-structures of the at least one surroundings feature 221 are recognized and—for example, by comparison to known structures, stored on the hard drive—are assigned to a particular object—as a function of the abstraction level of the object class and/or as a function of first surroundings sensor system 201. In one further specific embodiment, the object class is determined, for example, as a function of a material property of the at least one surroundings feature 221 in that color and/or brightness and/or intensity values of the detected surroundings data values are evaluated—based on the at least one surroundings feature 221 and/or as a function of first surroundings sensor 201—and—for example by comparison to known color and/or brightness and/or intensity values stored on the hard drive—are assigned.

Device 110 furthermore includes third means 113, which, for example, as a processing unit including electronic data processing elements (processor, working memory, hard drive, etc.), are designed to create an assignment of the object class to at least one further object class, the at least one further object class being determined proceeding from at least one further surroundings feature, the at least one further surroundings feature being detectable with the aid of a second surroundings sensor system, and the second surroundings sensor system not being identical in design to first surroundings sensor system 201.

Device 110 furthermore includes fourth means 114, which, for example, as a processing unit including electronic data processing elements (processor, working memory, hard drive, etc.), are designed to create a map, as a function of the surroundings data values, based on the assignment. In one specific embodiment, the first map is created by combining the second map and the at least one surroundings feature 221, as a function of the assignment, into the first map. For example, the at least one further surroundings feature, which is already encompassed by the second map, is identified in the process as the at least one surroundings feature 221 with the aid of the assignment and thus supplemented with another signature, as a function of the design of the first surroundings sensor system. In one specific embodiment, the first map is created in such a way that the first map can be combined with the second map and/or a further map. For example, the position of the at least one surroundings feature 221 is determined and/or corrected and/or adapted in the process with the aid of the assignment, so that the first map—if needed—may be combined with the second map and/or the one further map.

In one specific embodiment, the first map is created by creating an intermediate map, proceeding from the at least one surroundings feature 221, and combining the second map and the intermediate map, as a function of the assignment, into the first map. The intermediate map is created, for example, in such a way that surroundings data values detected by at least two vehicles, the surroundings data values at least partially representing shared surroundings, and the at least partially shared surroundings encompassing the at least one surroundings feature 221, are combined in advance—as the intermediate map. This takes place, in particular, by using the same surroundings sensor system which corresponds to first surroundings sensor system 201 of the at least one vehicle 200.

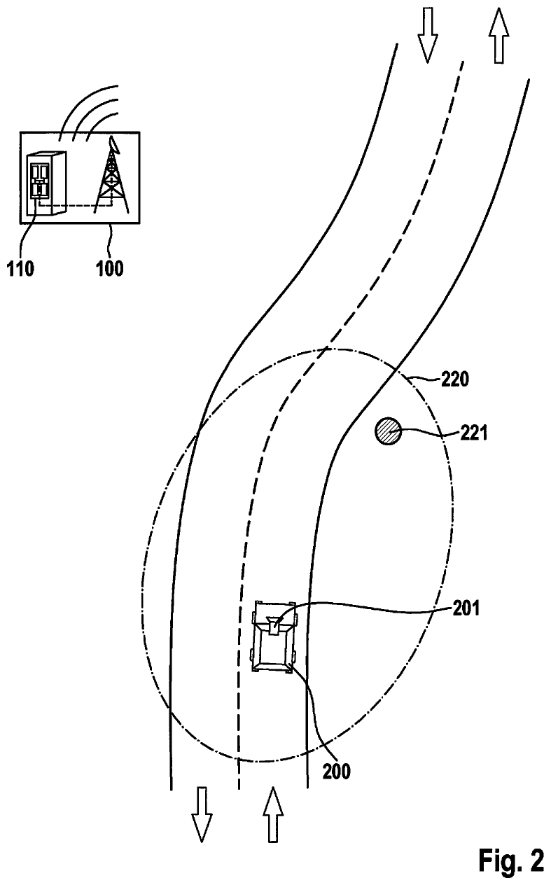

FIG. 2 shows one exemplary embodiment of method 300 according to the present invention for creating 340 a first map. Surroundings data values are received by device 110 in the process, the surroundings data values representing surroundings 220 of at least one vehicle 200, surroundings 220 encompassing at least one surroundings feature 221, the surroundings data values being detected with the aid of a first surroundings sensor system 201 of the at least one vehicle 200. In one specific embodiment, the at least one vehicle 200 includes a transceiver unit, for example, which is designed to transmit the surroundings data values to device 110. In one further specific embodiment, a mobile transceiver unit—in particular, a smart phone—used for this purpose, for example, which is encompassed by the at least one vehicle 200 and connected thereto by cable and/or a wireless connection—for example Bluetooth. In one further specific embodiment, the at least one vehicle 200 additionally and/or alternatively includes a navigation system and/or a smart phone and/or a further unit, which are designed to determine a position of the at least one vehicle 200 and/or to assign a position to the at least one surroundings feature 221, the accuracy of the position being determined, for example, as a function of the position of the at least one vehicle 200 and as a function of first surroundings sensor system 201. In one specific embodiment, the surroundings data values encompass the at least one surroundings feature 221 and the position of the at least one surroundings feature 221. Subsequently, the first map is created according to the individual steps of the described method 300.

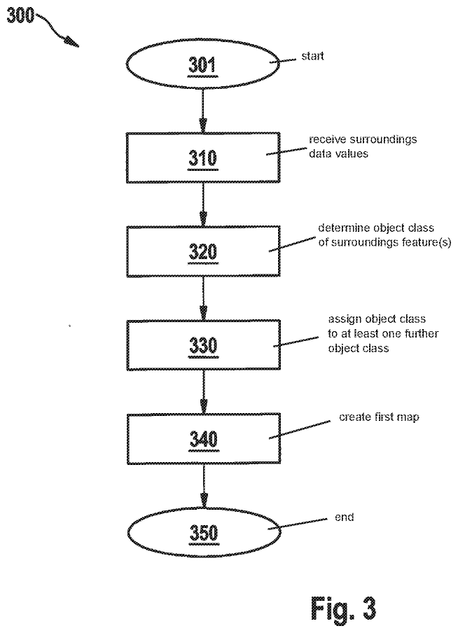

FIG. 3 shows one exemplary embodiment of a method 300 for creating 340 a first map.

In step 301, method 300 starts.

In step 310, surroundings data values are received, the surroundings data values representing surroundings 220 of at least one vehicle 200, surroundings 220 encompassing at least one surroundings feature 221, the surroundings data values being detected with the aid of a first surroundings sensor system 201 of the at least one vehicle 200.

In step 320, an object class of the at least one surroundings feature 221 is determined, as a function of first surroundings sensor system 201 of the at least one vehicle 200.

In step 330, an assignment of the object class to at least one further object class is created, the at least one further object class being determined proceeding from at least one further surroundings feature, the at least one further surroundings feature being detectable with the aid of a second surroundings sensor system, and the second surroundings sensor system not being identical in design to first surroundings sensor system 201.

In step 340, the first map is created, as a function of the surroundings data values, based on the assignment.

In step 350, method 300 ends.

1-8. (canceled)

9. A method for creating a first map, comprising the following steps:
receiving surroundings data values, the surroundings data values representing surroundings of at least one vehicle, the surroundings encompassing at least one surroundings feature, the surroundings data values being detected with using a first surroundings sensor system of the at least one vehicle;
determining an object class of the at least one surroundings feature as a function of the first surroundings sensor system of the at least one vehicle;
creating an assignment of the object class to at least one further object class, the at least one further object class being determined proceeding from at least one further surroundings feature, the at least one further surroundings feature being detectable using a second surroundings sensor system, and the second surroundings sensor system not being identical in design to the first surroundings sensor system; and
creating the first map as a function of the surroundings data values, based on the assignment.

10. The method as recited in claim 9, wherein:
(i) the at least one further surroundings feature is encompassed by a second map, and/or
(ii) a step of providing the first map takes place in such a way that: (a) an automated vehicle is operated as a function of the first map and/or as a function of the second map and/or as a function of the assignment, and/or (b) a mobile terminal is operated as a function of the first map and/or as a function of the second map and/or as a function of the assignment.

11. The method as recited in claim 9, wherein the object class is determined: (i) as a function of a geometrical structure of the at least one surroundings feature, and/or (ii) as a function of a material property of the at least one surroundings feature.

12. The method as recited in claim 11, wherein the assignment of the object class to the at least one further object class is created: (i) as a function of the geometrical structure of the at least one surroundings feature, and/or (ii) as a function of a geometrical structure of the at least one further surroundings feature.

13. The method as recited in claim 9, wherein:
(i) the first surroundings sensor system includes a radar sensor, the surroundings data values are detected using the radar sensor, the at least one surroundings feature includes a characteristic radar signature, and the object class is determined as a function of the characteristic radar signature, and/or
(ii) the second surroundings sensor system includes a video sensor and/or a LIDAR sensor.

14. The method as recited in claim 9, wherein the assignment is created, proceeding from the surroundings data values, using: a SLAM method, and/or a correlation method.

15. A device for creating a first map, the device comprising:
a first device configured to receive surroundings data values, the surroundings data values representing surroundings of at least one vehicle, the surroundings encompassing at least one surroundings feature, the surroundings data values being detected using a first surroundings sensor system of the at least one vehicle;
a second device configured to determine an object class of the at least one surroundings feature, as a function of the first surroundings sensor system of the at least one vehicle;
a third device configured to create an assignment of the object class to at least one further object class, the at least one further object class being determined proceeding from at least one further surroundings feature, the at least one further surroundings feature being detectable using a second surroundings sensor system, and the second surroundings sensor system not being identical in design to the first surroundings sensor system; and
a fourth device configured to create the first map, as a function of the surroundings data values, based on the assignment.

16. The device as recited in claim 15, wherein the first device includes a transceiver, and the second device, the third device, and the fourth device includes an electronic processor including a working memory.
